(19) United States
(12) Patent Application Publication
(10) Pub. No.: US 2008/0136750 A1
(43) Pub. Date: Jun. 12, 2008

(54) Pixel Addressing Circuit and Method of Controlling on Such Circuit

(75) Inventor: Walid Benzarti, Grenoble (FR)

Correspondence Address: OLIFF & BERRIDGE, PLC, P.O. BOX 320850, ALEXANDRIA, VA, 22320-4850, US

(73) Assignee: COMMISSARIAT A L'ENERGIE ATOMIQUE, Paris (FR)

(21) Appl. No.: 11/795,886

(22) PCT Filed: Feb. 16, 2006
(86) PCT No.: PCT/FR06/00363

§ 371 Date: Jul. 24, 2007

(30) Foreign Application Priority Data
Feb. 21, 2005 (FR) 0501731

(51) Int. Cl. G09G 3/32

(52) U.S. Cl. 345/76

(57) ABSTRACT

The pixel addressing circuit comprises two actuating transistors connected in series with a same diode to the terminals of a supply voltage, and two switching transistors each comprising a gate and respectively connected between data signals and the gate of the associated actuating transistors. The gates of the switching transistors are connected to two distinct outputs of a control circuit supplying them with different addressing voltages. The method for controlling the addressing circuit consists in applying addressing voltages to the gates of the switching transistors, which voltages are able to respectively turn the associated actuating transistors off and on so as to make one of the actuating transistors switch to an addressing and control phase of the diode and to make the other actuating transistor switch to a repair phase.

### BACKGROUND OF THE INVENTION

The invention relates to a pixel addressing circuit comprising, for each pixel, first and second control circuits respectively comprising:
first and second actuating transistors, made from amorphous silicon, each comprising a gate and each connected in series with an organic light-emitting diode to the terminals of a supply voltage,
first and second switching transistors, each comprising a gate and respectively connected between first and second data signals and the gate of the associated first and second actuating transistors,
first and second capacitors, respectively connected between the gate of the first and second actuating transistors and one of the supply voltage terminals,
   the addressing circuit controlling the first and second switching transistors to simultaneously, respectively and alternately turn the first and second actuating transistors off and on.

The invention also relates to a method for controlling such an addressing circuit.

### STATE OF THE ART

Organic Light Emission Displays (OLED) are flat monitors which use the luminescence properties of organic light-emitting diodes. Unlike liquid crystal displays (LCD) which are addressed in voltage, OLED diodes are addressed in current. To make OLED monitors work with the same conventional addressing structures used for LCD monitors, a voltage-current converter circuit has to be used.

As represented in FIG. 1, a conventional pixel control structure is composed of two transistors T1, T2, for example of MOSFET type, a capacitor C and an OLED diode D. The transistor T1 is an actuating transistor, operating as an analog voltage-controlled current generator. The actuating transistor T1 is connected in series with the diode D to the terminals of a supply voltage Vcc. It converts an actuating voltage Vg1 applied to its gate into current flowing in the diode D. The capacitor C is connected between the gate of the actuating transistor T1 and a fixed potential, for example ground, the supply voltage Vdc or another potential.

The transistor T2 is a switching transistor designed to determine whether the pixel has been selected or not, operating in binary digital manner, i.e. with an on position and an off position. The switching transistor T2 is controlled by an addressing voltage Vg2 applied to its gate, making the transistor T2 switch from its on position to its off position and vice versa. The switching transistor T2, enabling addressing of the pixel diode D, is connected between data signals Vd and the gate of the actuating transistor T1. The data signals Vd are thus transmitted, when the switching transistor T2 is on, to the gate of the actuating transistor T1 which transforms these voltage signals into current designed to control the lighting intensity of the diode D.

The transistors T1 and T2 are preferably amorphous silicon NMOS transistors of the Thin Film Transistor (TFT) type. The use of amorphous silicon for fabrication of the transistor T1 can however cause degradation of this transistor during addressing of the diode D, as the actuating transistor T1 operates as a current generator during more than 95% of the pixel addressing time.

This degradation of the actuating transistor T1 essentially results in a drift of its threshold voltage Vt. Several factors are at the origin of this drift. The first is due to diffusion of hydrogen into the amorphous silicon when the actuating transistor T1 is in operation, and the second, which is much more preponderant, is due to injection of carriers into the gate insulator of the actuating transistor T1, in this case nitride. These carriers are in fact stored in the nitride and play a memory effect role modifying the threshold voltage Vt of the actuating transistor T1.

To remedy this degradation, the document US 2004/0001037 proposes a circuit enabling the threshold voltage of the actuating transistor of a standard pixel control structure to be reduced by means of a modified addressing system. In particular the voltage applied to the drain of the actuating transistor, in series with the OLED diode, varies according to the voltage applied to the gate of the actuating transistor.

However, even if such a circuit enables the actuating transistor threshold voltage drift to be reduced, it does not enable the actuating transistor to be repaired, i.e. its lifetime to be increased and its operation to be optimized.

The article “Polarity-Balanced Driving to Reduce VTH Shift in a-Si for Active-Array OLEDs” by You B-H and al. (2004 Sid International Symposium Digest of Technical Papers, Seattle, May 25-27, 2004) describes an addressing circuit enabling the operation of its transistors to be enhanced. The circuit comprises two actuating transistors and four switching transistors operating with an even and odd addressing mode.

However the number of transistors and operation of the circuit imposes specific and different addressing modes for the transistors. This results in non-optimal operation of the addressing circuit and degradation of the transistors is still observed.

### OBJECT OF THE INVENTION

The object of the invention is to remedy these shortcomings and consists in providing a pixel addressing circuit enabling the dependability of the transistors and operation of the addressing circuit in time to be optimized.

The object of the invention is achieved by the accompanying claims and more particularly by the fact that the gates of the first and second switching transistors are connected to two distinct outputs of a control circuit supplying them with different addressing voltages.

It is a further object of the invention to provide a method for control of such an addressing circuit that is simple and easy to implement.

In particular, the method is characterized in that it comprises application of the addressing voltages to the gates of the first and second switching transistors during one or more data frames, which voltages respectively turn the associated actuating transistors off and on so as to make one of the actuating transistors switch to an addressing and control phase of the diode and the other actuating transistor switch to a repair phase, and alternately during one or more following data frames.

### BRIEF DESCRIPTION OF THE DRAWINGS

Other advantages and features will become more clearly apparent from the following description of particular embodiments of the invention given for non-restrictive example purposes only and represented in the accompanying drawings, in which:

FIG. 1 illustrates a conventional structure of a pixel control circuit according to the prior art.

FIG. 2 illustrates a particular embodiment of a pixel control circuit according to the invention.

FIGS. 3 and 4 illustrate a pixel array composed of lines and columns, each pixel being controlled by an addressing circuit according to FIG. 2, respectively for a data frame N and for a following data frame N+1.

FIGS. 5 to 10 illustrate operation of the transistors at different points of the addressing circuit according to FIG. 2 versus time, during two successive data frames N and N+1.

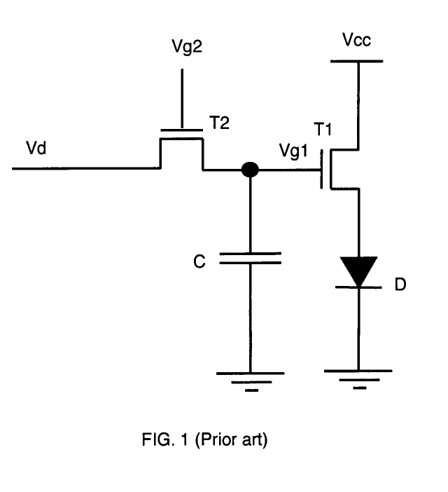

### DESCRIPTION OF PARTICULAR EMBODIMENTS

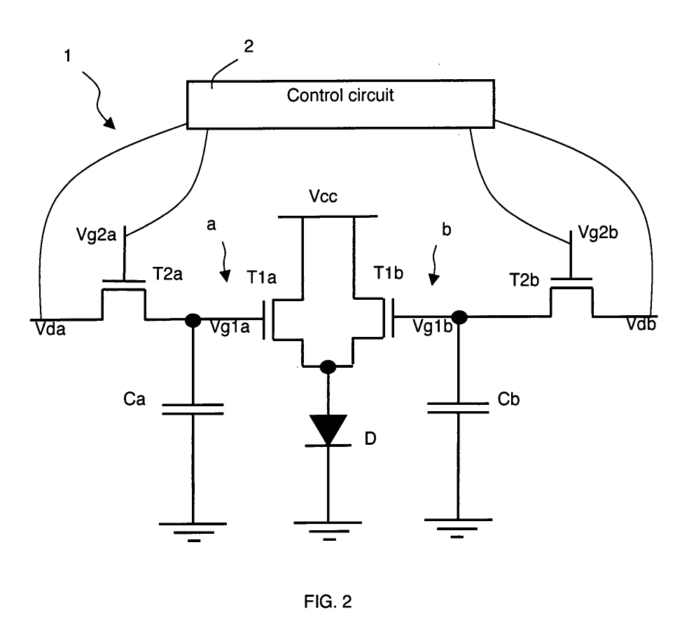

In FIG. 2, the addressing circuit 1 of a pixel comprises a first control circuit a, constituted by a structure according to the prior art. A first actuating transistor T1a is thus connected in series with the organic light-emitting diode D to the terminals of the supply voltage Vcc. An actuating voltage Vg1a is applied to the gate of the first actuating transistor T1a. The first control circuit also comprises a first capacitor Ca connected between the gate of the first actuating transistor T1a and a fixed potential, for example ground, in the particular embodiment of FIG. 2. A first switching transistor T2a, controlled by an addressing voltage Vg2a, between an on position and an off position, is connected between first data signals Vda and the gate of the first actuating transistor T1a.

The addressing circuit 1 comprises a second control circuit b, of identical structure to the first control circuit a, comprising a second actuating transistor T1b connected in series with the diode D to the terminals of the supply voltage Vcc. A second capacitor Cb is connected between the gate of the second actuating transistor T1b and a fixed potential, for example ground. An actuating voltage Vg1b is applied to the gate of the second actuating transistor T1b. The second control circuit b also comprises a second switching transistor T2b controlled by an addressing voltage Vg2b applied to the transistor gate and connected between second data signals Vdb and the gate of the second actuating transistor T1b.

The data signals Vda and Vdb and the addressing voltages Vg2a and Vg2b of the switching transistors T2a and T2b are supplied by a control circuit 2 (FIG. 2) performing both control of the diode D and alternately repair of the actuating transistors T1a and T1b.

In the particular embodiment of FIG. 2, the first and second switching transistors T2a, T2b are connected to two distinct outputs of the control circuit 2. This circuit can then respectively supply these transistors with different addressing voltages Vg2a, Vg2b.

Moreover, in an alternative embodiment that is not represented, the first and second switching transistors T2a, T2b can be supplied by identical data signals Vda, Vdb (Vda=Vdb). Such a configuration then enables the number of signals to be conveyed to the addressing circuit 1 to be limited.

To repair degradation of the threshold voltage observed on the gate of the actuating transistor T1a, a voltage able to turn this transistor off is temporarily applied to this gate during a repair phase. This voltage has to be lower than the voltages at the source and drain of this transistor. A negative voltage is for example applied to the gate of the actuating transistor T1a. This causes removal of the carriers that were injected into the nitride.

While the actuating transistor T1a is in the repair phase, the diode D is controlled by the second actuating transistor T1b, which is in the addressing phase and operates as a current generator. For this, it receives positive actuating signals Vg1b on its gate. Thus, while one of the control circuits (a or b) is assigned to addressing and control of the diode D, the other control circuit (b or a) repairs its actuating transistor, not solicited for addressing and control of the diode D.

Thus, when the diode D is addressed and controlled by means of the first actuating transistor T1a, the second actuating transistor T1b is being repaired. It is then turned off and only a very weak current, less than 10⁻¹⁰ A, is flowing in its channel. The voltage at the terminals of the transistor then does not influence either the first actuating transistor T1a or correct operation of the diode D. In opposite manner, when the diode D is addressed and controlled by means of the second actuating transistor T1b, the first actuating transistor T1a is being repaired and the voltage at its terminals does not influence either the second actuating transistor T1b or correct operation of the diode D.

In the preferred embodiment of FIG. 2, the gates of the actuating transistors T1a and T1b are respectively connected to the voltages Vda and Vdb by means of the first and second switching transistors T2a and T2b. For example, during a frame N of the data signals Vda and Vdb, the control circuit 2 simultaneously applies a positive data voltage Vda, designed to control the diode D, to the drain of the switching transistor T2a of the first control circuit a, and a negative data voltage Vdb, designed for repair of the gate of the actuating transistor T1b, to the drain of the second switching transistor T2b of the second control circuit b.

In a subsequent frame, i.e. the next frame N+1, the control circuit 2 supplies negative data signals Vda and positive data signals Vdb so that the actuating transistor T1a switches to repair phase while the second actuating transistor T2b, repaired beforehand, then switches to the addressing and control phase of the diode D.

Such an addressing circuit 1 with two identical control circuits a and b associated with a single diode D therefore enables addressing and control of the diode D and repair of the actuating transistors T1a, T1b of this diode D to be performed simultaneously, respectively and alternately, in order to improve the operating lifetime of the addressing circuit 1.

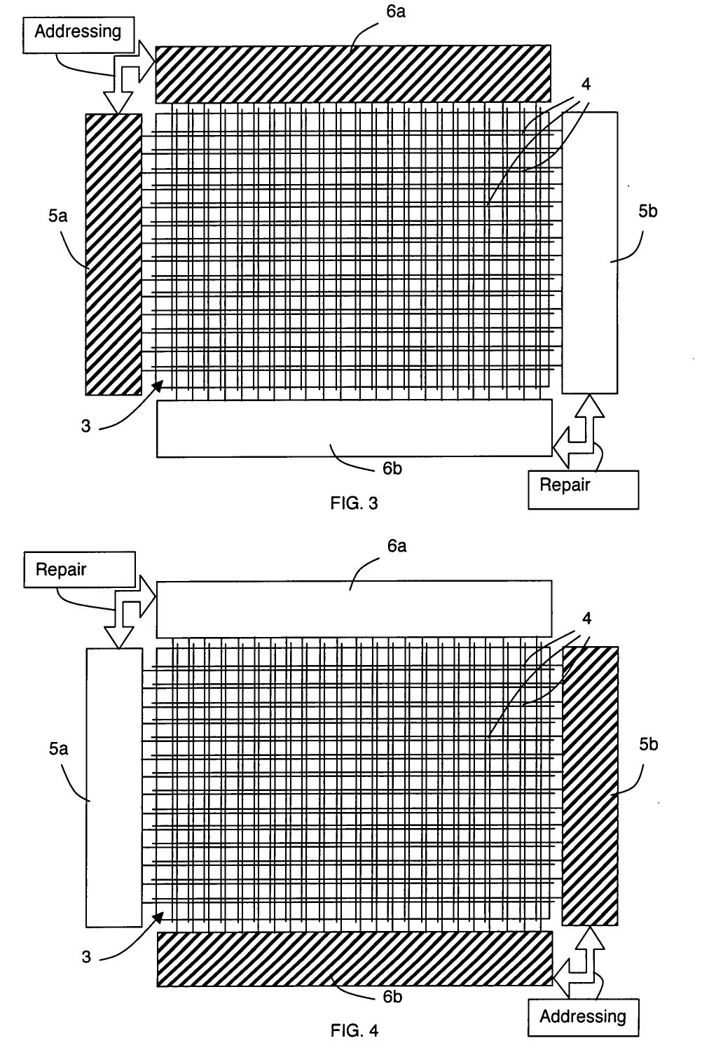

In FIGS. 3 and 4, an array 3 composed of a plurality of pixels 4 disposed in a plurality of lines and columns represents a particular embodiment of arrangement of pixels 4. In the particular embodiment represented in FIGS. 3 and 4, each pixel 4 is addressed by an addressing circuit 1 according to FIG. 2 and the control circuit 2 of each pixel 4 comprises a first addressing circuit 5a of the lines of the array 3, located for example to the left of the array 3, and a second addressing circuit 5b of the lines of the array 3, located for example to the right of the array 3.

The control circuit 2 also comprises a first addressing circuit 6a of the columns of the array 3, located for example at the top of the array 3, and a second addressing circuit 6b of the columns of the array 3, located for example at the bottom of the array 3.

In FIGS. 3 and 4, the circuits 5a and 6a are respectively connected to the gate and drain of the switching transistor T2a of each pixel 4 and respectively supplying the addressing voltages Vg2a and the data signals Vda of each pixel 4. In a similar way, the circuits 5b and 6b are respectively connected to the gate and drain of the switching transistor T2b of each pixel 4 and respectively supply the addressing voltages Vg2b and the data signals Vdb of each pixel 4.

FIGS. 3 and 4 illustrate the state of the array 3 during two successive operation frames. The addressing circuit 5a of the lines and the addressing circuit 6a of the columns are designed for alternatively addressing and controlling the diodes of the pixels 4 (FIG. 3) and for repairing the actuating transistors T1a of the diodes D of the pixels 4 (FIG. 4). At the same time, the addressing circuit 5b of the lines and the addressing circuit 6b of the columns are designed for alternatively repairing the actuating transistors T1b of the diodes D of the pixels 4 (FIG. 3) and for addressing and controlling the diodes of the pixels 4 (FIG. 4).

The use of two addressing circuits 5a and 5b of the lines of the array 3 and two addressing circuits 6a and 6b of the columns of the array 3 represents a solution enabling a greater latitude for biasing the array 3 to be had. Moreover, the particular structure of the addressing circuits 1 facilitates arrangement as an array 3, as it is easy to connect additional transistors to already existing addressing circuits.

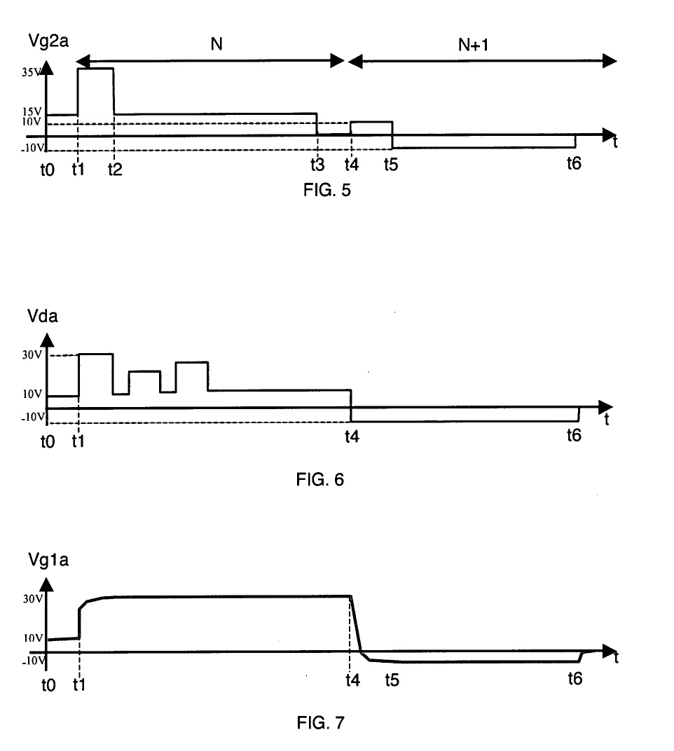

Operation of the addressing circuit 1 according to FIG. 2 will be described in greater detail with regard to FIGS. 5 to 10. As described above, operation of such an addressing circuit 1 consists in simultaneously applying signals of opposite polarities to the gates of the actuating transistors T1a and T1b of the addressing circuit 1, respectively during one and the same frame and alternately during two successive frames, which frames may be adjacent or not.

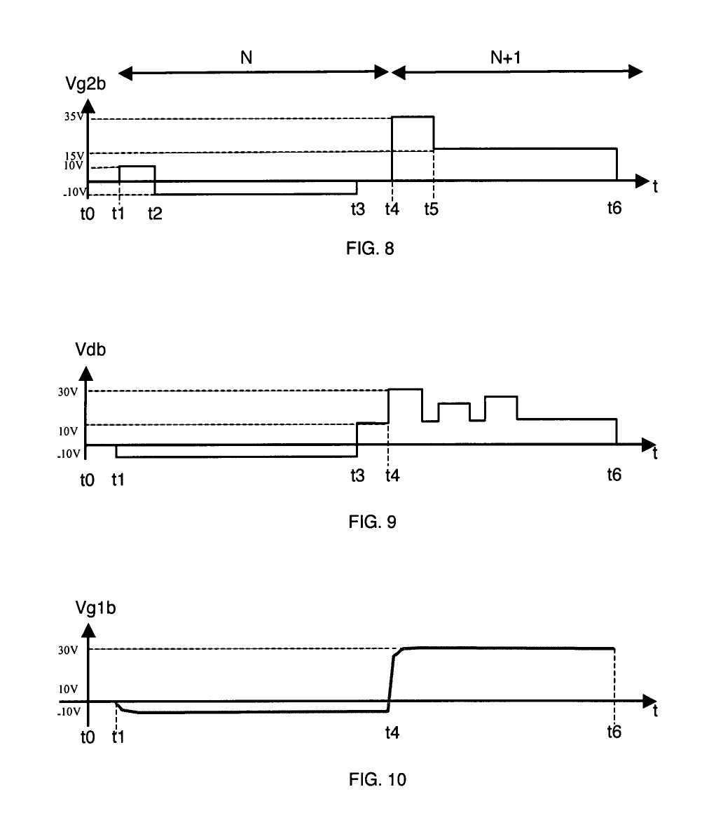

For example, as represented in FIGS. 5 to 10, the first control circuit is first designed for addressing and controlling the diode D during the frame N, whereas the second control circuit b is simultaneously designed for repairing the gate of the actuating transistor T1b. As represented in FIGS. 5 and 6, at a time t0, the voltage Vg2a applied to the gate of the first switching transistor T2a is positive, for example about 15V, and the data signals Vda applied to the drain of the switching transistor T2a are about 10V. At the same time, as represented in FIGS. 8 to 10, whereas the actuating voltage Vg1a (FIG. 7) applied to the gate of the first actuating transistor T1a is about 10V, the voltage Vg2b on the gate of the second switching transistor T2b and the data signals Vdb are at 0V. The actuating voltage Vg1b applied to the gate of the second actuating transistor T1b (FIG. 8) is also equal to 0V.

At a time t1 corresponding to the beginning of a frame N, the control circuit 2 applies a voltage, for example about 35V, for a predetermined duration of the frame, up to a time t2, turning the switching transistor T2a on (FIG. 5). The data signals Vda (FIG. 6), which can oscillate between 15V and 30V, are then transmitted (Vg1a, FIG. 7) to the gate of the actuating transistor T1a which then starts to control the diode D. Indeed, as represented in FIG. 7, the voltage Vg1a on the gate of the first actuating transistor T1a goes to 30 V at the time t1, corresponding to the value of the data signals Vda during the period going from the time t1 to the time t2 (FIG. 6).

The switching transistor T2a returning to its off position at time t2, when its addressing voltage Vg2a drops back to a voltage of about 15V (FIG. 5), does not have any influence on the voltage Vg1a applied to the gate of the first actuating transistor T1a (FIG. 7), due to the capacitor Ca connected to the gate of the actuating transistor T1a. The voltage Vg1a therefore remains at 30V up to a time t4 corresponding to the end of the frame N and to the beginning of the frame N+1. The actuating transistor T1a thus remains in the addressing and control phase of the diode D throughout the duration (t1 to t4) of the frame N.

As represented in FIG. 8, the voltage Vg2b applied to the gate of the second switching transistor T2b goes to 10V at time t1, then to −10V at time t2, before reverting to 0V at a time t3 slightly before the time t4.

At the same time, as represented in FIG. 9, the control circuit 2 applies negative data signals Vdb, for example about −10V, to the drain of the transistor T2b right from the beginning of the frame N, between time t1 and time t3. As illustrated in FIG. 10, the voltage Vg1b applied to the gate of the second actuating transistor T1b then goes to −10V throughout the whole duration (t1 to t4) of the frame N, which thus corresponds to the repair phase of the second actuating transistor T1b, which remains off throughout this period.

Slightly before the end of the frame N, at time t3, the voltages Vg2a (FIG. 5) and Vg2b (FIG. 8) applied to the gates of the two switching transistors T2a and T2b switch simultaneously to 0V to prepare the next frame. In FIGS. 6 and 8, the data signals Vda of the first control circuit remain at 10V, whereas the data signals Vdb of the second control circuit b go to about 15V (FIG. 8). These modifications do not have any influence on the voltages Vg1a and Vg1b, as the switching transistors T2a and T2b are then both off.

At time t4, the frame N+1 begins. As represented in FIGS. 5 and 6, the control circuit 2 then supplies data signals Vda of about −10V and the voltage Vg2a applied to the gate of the first switching transistor T2a goes to 10V up to a time t5. The transistor T2a is then on and transmits the negative voltage of the signals Vda to the gate of the first actuating transistor T1a. As represented in FIG. 7, the voltage Vg1a applied to the gate of the first actuating transistor T1a thus quickly takes the value −10V. It is kept at this value by means of the capacitor Ca until the end of the frame N+1, i.e. at a time t6, despite turn-off of the first switching transistor T2a, at time t5 when the voltage Vg2a goes to a value of about −10V (FIG. 5).

At the same time, as represented in FIGS. 8 to 10, at time t4, the second switching transistor T2b is turned on, for example by applying a voltage Vg2b of about 35V, whereas the data signals Vdb are positive and can oscillate, for example between 15V and 30V. The transistor T2b is thus on at the beginning of this frame N+1 and the voltage Vg1b applied to the gate of the actuating transistor T1b becomes positive, with a value of about 30V. It keeps this value until the end of the frame N+1, at time t6, due to the presence of the capacitor Cb. The switching transistor T2b possibly returning to its off position at time t5, when the voltage Vg2b goes to a value of about 15 V (FIG. 8) does not in fact have any influence on the voltage Vg1b applied to the gate of the second actuating transistor T1b.

Thus, more generally, at the beginning of the frame N, the addressing signals Vg2a turn the first switching transistor T2a on and thus transmit the data signals Vda to the gate of the actuating transistor T1a, which signals are able to make this transistor operate as a current generator. The voltage Vg1a remains substantially constant throughout the duration of the frame and controls lighting of the diode D. The voltage Vg2b applied to the gate of the actuating transistor T1b during this frame turns this transistor off and enables the gate of the actuating transistor T1b to be repaired.

In the next frame N+1, which may be adjacent or not, the switching transistors T2a and T2b are turned on as the voltage Vg2a is about 10V and the voltage Vg2b is about 35V, whereas the data signals Vdb turn the actuating transistor T1b on and the data signals Vda turn the actuating transistor T1a off. The first control circuit a then in turn switches to repair phase of the first actuating transistor T1a, whereas the second control circuit b in turn switches to the addressing and control phase of the diode D.

Operation continues in this way, each control circuit being alternately assigned to repair of its actuating transistor and to addressing and control of the diode, during one or more frames. Operation is therefore very simple and made easier by the use of addressing circuits comprising two identical control circuits.

The invention is not limited to the different embodiments described above. The voltage values are not limited to those indicated above and operation is identical with other values compatible with the type and size of the actuating transistors T1a and T1b and the switching transistors T2a and T2b. The polarities of the voltages may be modified, so long as the general principle of the addressing circuit 1 is kept, i.e. with a repair phase and an addressing and control phase of the diode performed simultaneously, respectively and alternately by each control circuit.

In the case of the pixels 4 being arranged in an array 3, as represented in FIGS. 3 and 4, a feedback system can be installed by placing photodiodes in some pixels 4 to modify the value of the turn-off voltage over time, according to the luminance of the monitor.

This type of addressing circuit enabling repair of amorphous silicon transistors can be envisaged in any application using this type of transistors in continuous or almost continuous operation as a current generator, in an analog circuit. The main applications are for example medical imaging, microfluidics, etc.

It could apply more generally to any type of transistor having a threshold voltage that drifts in time in this type of operation for similar reasons to those observed for amorphous silicon transistors.

1-10. (canceled)

11. A pixel addressing circuit comprising, for each pixel, first and second control circuits respectively comprising:
first and second actuating transistors made from amorphous silicon, each comprising a gate and each connected in series with an organic light-emitting diode to the terminals of a supply voltage,
first and second switching transistors, each comprising a gate and respectively connected between first and second data signals and the gate of the associated first and second actuating transistors,
first and second capacitors, respectively connected between the gate of the first and second actuating transistors and one of the supply voltage terminals,
the addressing circuit controlling the first and second switching transistors to simultaneously, respectively and alternately turn the first and second actuating transistors off and on, the gates of the first and second switching transistors being connected to two distinct outputs of a control circuit supplying them with different addressing voltages.

12. The addressing circuit according to claim 11, wherein the pixels being arranged in the form of an array of lines and columns, the control circuit comprises:
first and second line addressing circuits, arranged on each side of the array and respectively connected to the first data signals of the first switching transistor and to the second data signals of the second switching transistor, and first and second column addressing circuits, arranged on each side of the array and respectively connected to the gate of the first switching transistor and to the gate of the second switching transistor.

13. The addressing circuit according to claim 11, wherein the first and second switching transistors are supplied by identical data signals.

14. A method for controlling an addressing circuit according to claim 11, comprising application, during one or more data frames, of the addressing voltages to the gates of the first and second switching transistors, which voltages are able to turn the associated actuating transistors respectively off and on so as to make one of the actuating transistors switch to an addressing and control phase of the diode and to make the other actuating transistor switch to a repair phase, and alternately during one or more subsequent data frames.

15. The method according to claim 14, wherein, during a first predetermined period corresponding to the beginning of a frame, the addressing voltage applied to the gate of the switching transistor able to turn the associated actuating transistor on takes a first positive value, greater than the addressing voltage applied to the gate of the switching transistor able to turn the associated actuating transistor off.

16. The method according to claim 15, wherein the addressing voltage applied to the gate of the switching transistor able to turn the associated actuating transistor on is about 35V and the addressing voltage applied to the gate of the switching transistor able to turn the associated actuating transistor off is about 10V.

17. The method according to claim 15, wherein the addressing voltage applied to the gate of the switching transistor able to turn the associated actuating transistor on takes a second positive value during a second predetermined period.

18. The method according to claim 17, wherein the addressing voltage applied to the gate of the switching transistor able to turn the associated actuating transistor off simultaneously takes a negative value during said second predetermined period.

19. The method according to claim 18, wherein said second positive value is about 15V and said negative value is about −10V.

20. The method according to claim 14, wherein the addressing voltages applied to the gates of the first and second switching transistors are simultaneously equal to zero during a third predetermined period corresponding to the end of a frame.
